(19) United States
(12) Patent Application Publication
(10) Pub. No.: US 2022/0312664 A1
(43) Pub. Date: Oct. 6, 2022

(54) HANDHELD TRENCHER ATTACHMENTS

(71) Applicant: TerraTrench USA, Inc., Vancouver, WA (US)

(72) Inventors: Peter BLUNDELL, Vancouver, WA (US); James Joseph HARRIS, Vancouver, WA (US)

(73) Assignee: TerraTrench USA, Inc., Vancouver, WA (US)

(21) Appl. No.: 17/701,549

(22) Filed: Mar. 22, 2022

Related U.S. Application Data
(60) Provisional application No. 63/168,421, filed on Mar. 31, 2021.

(51) Int. Cl. A01C 5/06

(52) U.S. Cl. CPC A01C 5/062

(57) ABSTRACT

Handheld trencher attachment assemblies are disclosed. In one embodiment, the assembly includes a base having digging bar and power cutter portions. The digging bar portion having opposed first and second sides and an opening that extends between the sides. The power cutter portion includes a plurality of spaced holes sized to receive bolts to attach the power cutter portion to a power cutter. The assembly additionally includes a drive axle rotatably received in the opening. The drive axle includes opposed first and second longitudinal ends. The assembly further includes a drive sprocket attached to the first longitudinal end. The drive sprocket includes teeth that meshes with a digging chain. The assembly additionally includes a drive pulley attached to the second longitudinal end. The drive pulley includes a groove around a circumference of the drive pulley. The groove is sized to receive a drive belt of the power cutter.

### CROSS-REFERENCE TO RELATED APPLICATIONS

This application claims the benefit of U.S. Provisional Patent Application Ser. No. 63/168,421 filed on Mar. 31, 2021 and entitled “Handheld Trencher Attachments.” The complete disclosure of the above application is hereby incorporated by reference for all purposes.

### BACKGROUND OF THE DISCLOSURE

The present disclosure is directed to a handheld trencher attachment that can be attached to a cutoff saw or power cutter to transform the cutter into a handheld trencher. Notably, the process may be reversible, where upon removing the trencher attachment and assembling the originally removed components of the power cutter, the trencher may be transformed back into a power cutter, reducing waste and resources in the process.

Currently, trencher adapter kits may be purchased to convert a number of cutoff saws (also called power cutters) into handheld or wheel mounted lightweight trenchers. Trenchers are often used to create trenches that are narrow in width and shallow in depth for the installation of lighting, piping, electrical, plumbing for irrigation or landscaping purposes. In contrast, power cutters are often used to saw through bulk material that is dense, such as concrete, rock and other construction materials.

The prior art method includes removing and fully disassembling the outer arm of the power cutter. In the process of disassembly, the cutting blade, blade shroud, labyrinths and possibly the shaft and pulley are removed from the arm, along with other fasteners and smaller parts. After that, certain disassembled parts are then reused with the trencher adapter kit to construct the outer trenching arm in the location that was originally the outer arm of the power cutter. In this step, an adapter plate may be bolted onto the outer arm along with a new shaft, pulley, chain drive sprocket, digging bar and chain that comes with the trencher adapter kit. Given that the parts need to be fully disassembled, sorted, and subsequently combined with the individual parts of the trencher adapter kit, the conversion process is arduous and takes approximately 30 minutes. Given that the process is intricate, oftentimes, the adapter kits may also be pre-installed by authorized dealers, where the dealers may opt to convert the trencher first prior to retail. A large setback with this method, however, is that unused parts are typically discarded, and the trencher cannot be converted back to a power cutter.

What is desired, therefore, is a new attachment that converts the power cutter into a handheld trencher, where the process of assembly may be shortened and more easily reversed, should a user wish to switch from a trencher back to a power cutter so as to minimize waste of resources and time.

### BRIEF DESCRIPTION OF THE SEVERAL DRAWINGS

For a better understanding of the present disclosure, and to show how the same may be carried into effect, reference will now be made, by way of example to the accompanying drawings, which:

FIG. 1 is an isometric view of a handheld trencher attachment of the present disclosure shown without a digging chain;

FIG. 2 is another isometric view of the handheld trencher attachment of FIG. 1;

FIG. 3 is a side view of the handheld trencher attachment of FIG. 1 shown without dirt deflectors and mud flaps;

FIG. 4 is an opposite side view of the handheld trencher attachment of FIG. 1 shown without dirt deflectors and mud flaps;

FIG. 5 is a sectional view of the handheld trencher attachment of FIG. 1 taken along lines 5-5 in FIG. 1;

FIG. 6 is an exploded view of the handheld trencher attachment of FIG. 1; and

FIGS. 7-10 show side views of a power cutter being converted to a handheld trencher using the handheld trencher attachment of FIG. 1.

### DETAILED DESCRIPTION OF PREFERRED EMBODIMENTS

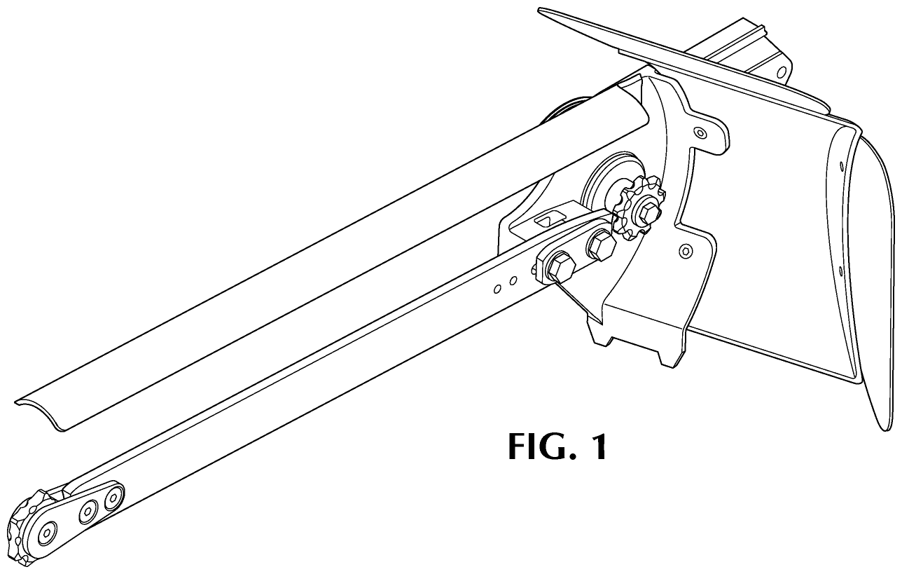

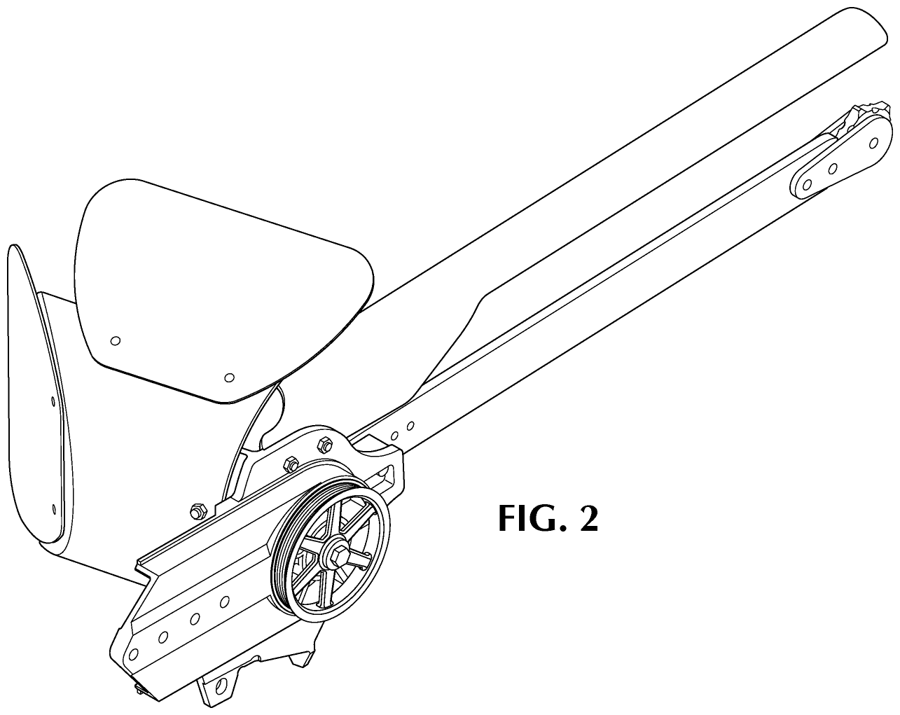

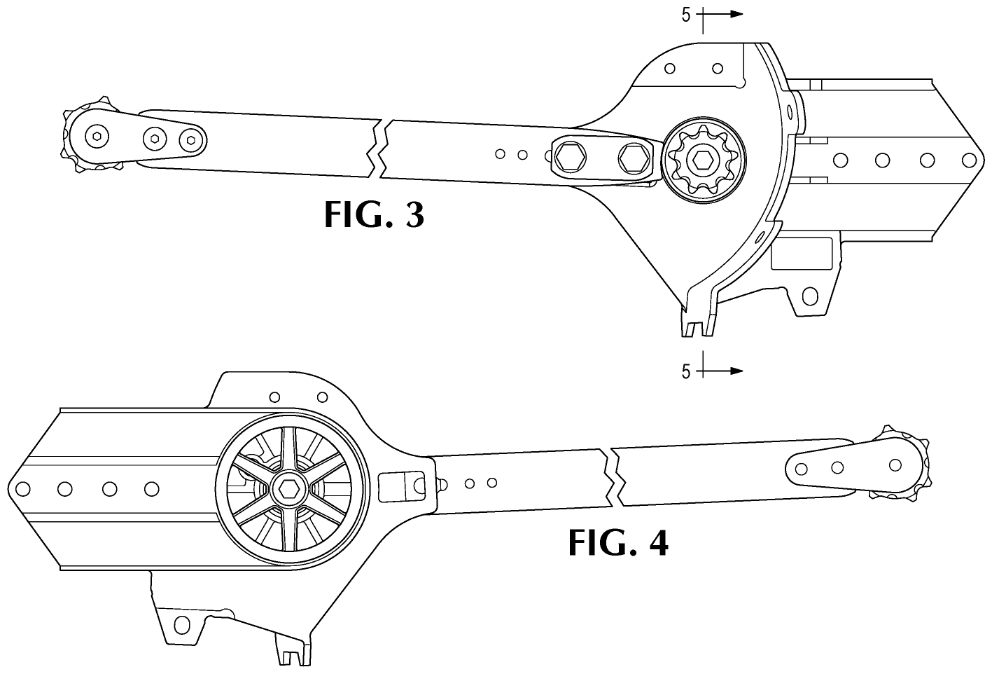

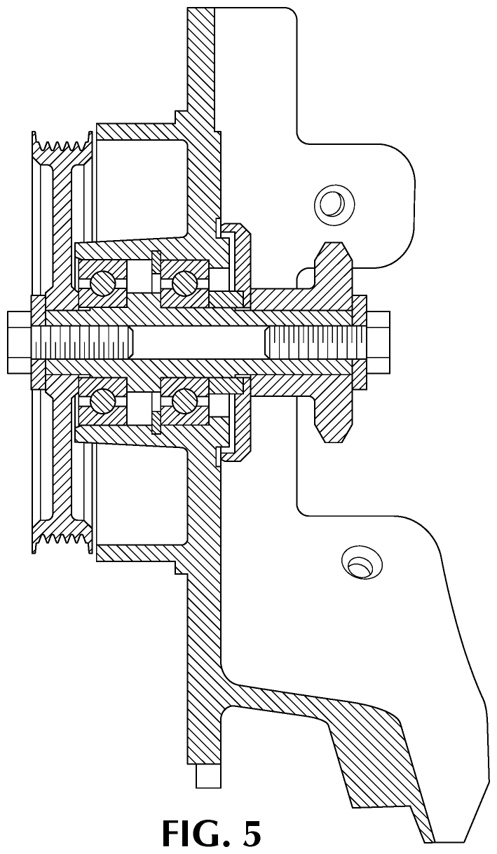

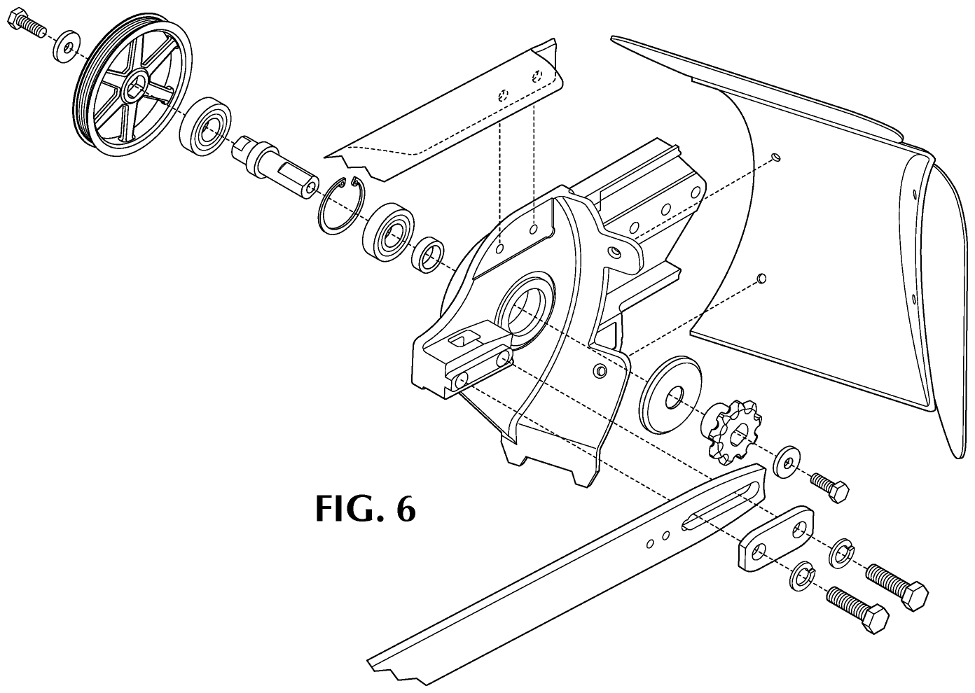

Referring to FIGS. 1-6, a handheld trencher attachment 10 is shown. The handheld trencher attachment includes a base 12 having a digging bar portion 14, a power cutter portion 16, and a deflector portion 18. The digging bar, power cutter, and deflector portions may be formed together and/or attached together. In the example shown in FIGS. 1-6, the digging bar and power cutter portions are in planes that are parallel to each other, while the deflector portion is disposed between the digging bar and power cutter portions and extends perpendicular to the planes of the digging bar and power cutter portions. Digging bar portion 14 includes opposed first and second sides 20 and 22 and an opening 24 that extends between the first and second sides. Power cutter portion 16 includes a plurality of spaced holes 26 to allow connection to a power cutter. In the example shown in FIGS. 1-6, deflector portion 18 is arcuate and includes spaced holes 28 to receive rear dirt deflector 30.

In the example shown in FIGS. 1-6, one or more mud flaps 32 are attached to the rear dirt deflector. Rear dirt deflector is arcuate but may alternatively, or additionally, be other shapes. Additionally, a forward dirt deflector 34 is attached to digging bar portion 14. The forward dirt deflector extends away from base 12 and may be parallel to and/or have substantially the same length as the digging bar (discussed below). Other examples of handheld trencher attachment 10 may include more or less dirt deflectors and/or mud flaps, different sized dirt deflectors and/or mud flaps, and/or different shaped dirt deflectors and/or mud flaps.

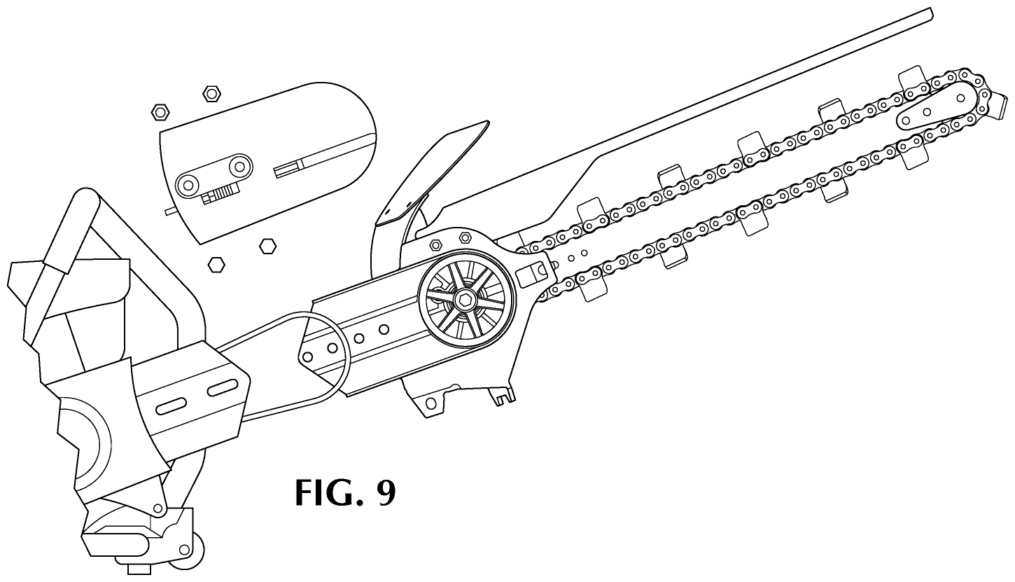

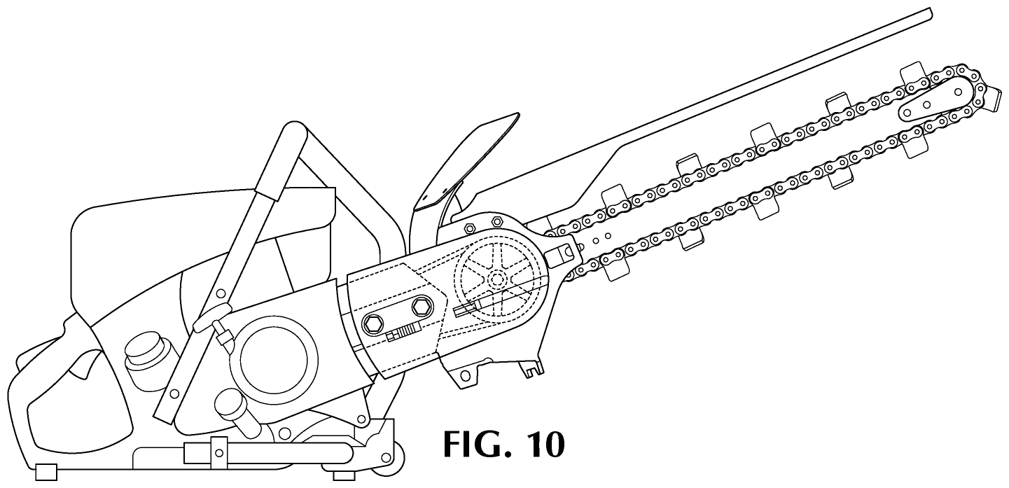

Handheld trencher attachment 10 additionally includes an axle assembly 36. The axle assembly includes a drive axle 38 rotatably received in opening 24 of digging bar portion 14. Ball bearings 39 are attached and positioned within opening 24 to allow drive axle 38 to rotate relative to digging bar portion 14. The drive axle includes opposed first and second longitudinal end portions 40 and 42. A drive sprocket 44 is attached or fixedly attached to first end portion 40. Drive sprocket 44 includes a plurality of teeth 46 that are sized to mesh or engage with a digging chain 48 (see FIGS. 9-10). Additionally, a drive pulley 50 is attached or fixedly attached to second end portion 42. The drive pulley includes a circumferential groove 52 that is sized to receive and/or engage with a drive belt of a power cutter. When drive pulley 50 is attached to the drive belt of the power cutter, rotation of the drive pulley results in rotation of drive axle 38, drive sprocket 44, and digging chain 48.

Handheld trencher attachment 10 further includes a digging bar assembly 54 having opposed longitudinal end portions 56 and 58. The digging bar assembly includes an elongate digging bar 60, a follower sprocket 62, and a pair of flanges 64 and 66 that rotatably attaches the follower sprocket to the elongate digging bar. The follower sprocket is spaced from the elongate digging bar via the flanges to allow rotation of the follower sprocket. Follower sprocket 62 includes a plurality of teeth 68 that mesh or engage with digging chain 48. Elongate digging bar 60 is attached or fixedly attached to first side 20 of digging bar portion 14 adjacent to drive sprocket 44 such that, when digging chain 48 is installed, the drive sprocket meshes or engages digging chain 48 when received in digging bar assembly 54. In the example shown in FIGS. 1-6, the elongate digging bar is attached or fixedly attached to a raised portion 70 on first side 20 of digging bar portion 14.

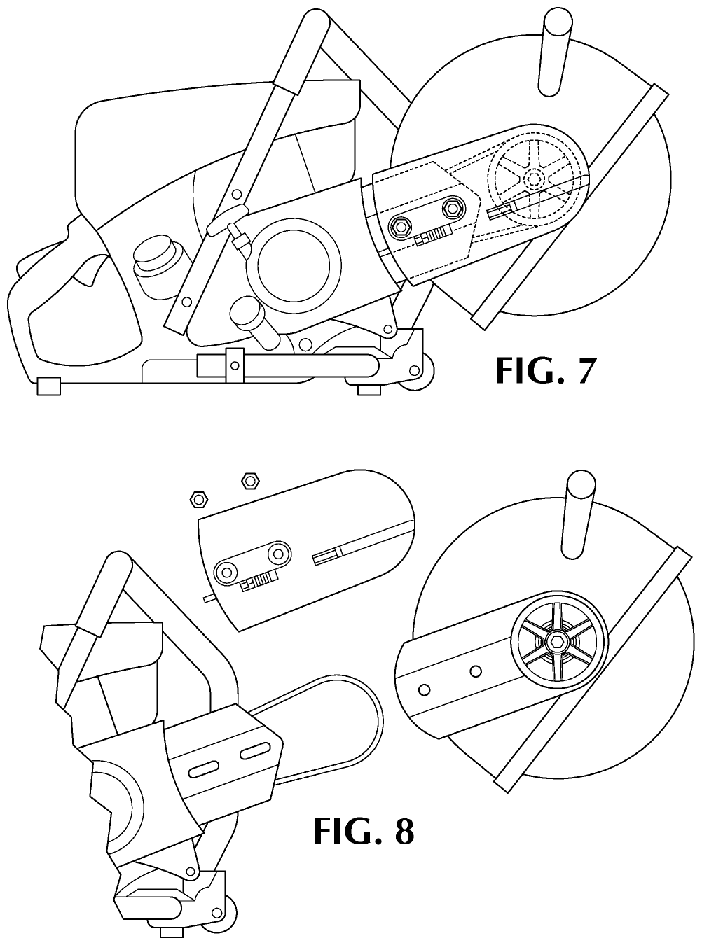

Referring to FIGS. 7-10, an example of a method of converting a power cutter 100 to a handheld trencher 200 is shown. In FIGS. 7-8, fasteners 104 and a belt cover 106 of power cutter 100 is removed and a cutting attachment 108 is detached from drive belt 110 of power cutter 100. In FIGS. 9-10, handheld trencher attachment 10 is positioned adjacent power cutter 100 and drive belt 110 is wrapped around drive pulley 50 of the handheld trencher attachment. Holes 26 of power cutter portion 16 are aligned with holes 111 of power cutter 100 and holes 112 of belt cover 106 and fasteners 202 are used to attach the power cutter and handheld trencher attachment together. Fasteners 202 may be the same or different from fasteners 104. When fasteners 202 are different from fasteners 104, fasteners 104 needs to be stored for so that the handheld trencher can be converted back to the power cutter. Handheld trencher 200 may be converted back to power cutter 100 by simply reversing the above process and using the stored fasteners 104 (when different from fasteners 202).

As compared to the prior art, handheld trencher attachment 10 allows a user to convert between a power cutter and a handheld trencher quickly (e.g., less than five minutes) and easily with a minimal number of parts required for the conversion. At most, only a few fasteners need to be stored to allow for re-conversion of the handheld trencher back to the power cutter.

It will be appreciated that the invention is not restricted to the particular embodiment that has been described, and that variations may be made therein without departing from the scope of the invention as defined in the appending claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. Further, the reference numbers, design, and components in the figures are merely illustrative and may be subject to change. The word “comprise” or a derivative thereof, when used in a claim, is used in a nonexclusive sense that is not intended to exclude the presence of other elements or steps in a claimed structure or method.

What is claimed is:

1. A handheld trencher attachment assembly, comprising:
a base having a digging bar portion and a power cutter portion, the digging bar portion having opposed first and second sides and an opening that extends between the first and second sides, the power cutter portion having a plurality of spaced holes sized to receive bolts to attach the power cutter portion to a power cutter;
a drive axle rotatably received in the opening, the drive axle having opposed first and second longitudinal ends;
a drive sprocket attached to the first longitudinal end of the drive axle, the drive sprocket having teeth that meshes with a digging chain; and
a drive pulley attached to the second longitudinal end of the drive axle, the drive pulley including a groove around a circumference of the drive pulley, the groove being sized to receive a drive belt of the power cutter.

2. The assembly of claim 1, wherein the digging bar and power cutter portions are along planes that are parallel to each other.

3. The assembly of claim 2, wherein the base further includes a deflector portion that is disposed between the digging bar and power cutter portions and that extends perpendicular to the planes of the digging bar and power cutter portions.

4. The assembly of claim 3, further comprising a first dirt deflector attached to the deflector portion.

5. The assembly of claim 4, wherein the first dirt deflector is arcuate.

6. The assembly of claim 4, further comprising one or more mud flaps attached to the dirt deflector.

7. The assembly of claim 4, further comprising a second elongate dirt deflector attached to the first side of the digging bar portion.

8. The assembly of claim 1, further comprising a digging bar assembly attached to the first side of the digging bar portion adjacent the drive sprocket.

9. The assembly of claim 8, further comprising the digging chain received by the drive sprocket and the digging bar assembly.

10. A handheld trencher attachment assembly, comprising:
a base having a digging bar portion, a power cutter portion, and a deflector portion that is disposed between the digging bar portion and the power cutter portion and that extends perpendicular to the planes of the digging bar portion and the power cutter portion, the digging bar portion having opposed first and second sides and an opening that extends between the first and second sides, the power cutter portion having a plurality of spaced holes sized to receive bolts to attach the power cutter portion to a power cutter;
a drive axle rotatably received in the opening, the drive axle having opposed first and second longitudinal ends;
a drive sprocket attached to the first longitudinal end of the drive axle;
a drive pulley attached to the second longitudinal end of the drive axle, the drive pulley including a groove around a circumference of the drive pulley, the groove being sized to receive a drive belt of the power cutter;
a digging bar assembly attached to the first side of the digging bar portion adjacent the drive sprocket; and
a digging chain received by the drive sprocket and the digging bar assembly, wherein, the drive sprocket includes teeth that meshes with the digging chain.

11. The assembly of claim 10, further comprising:
a first dirt deflector attached to the deflector portion; and
a second dirt deflector attached to the first side of the digging bar portion.

12. The assembly of claim 11, further comprising one or more mud flaps attached to the first dirt deflector.
